(19) United States
(12) Patent Application Publication
(10) Pub. No.: US 2008/0096520 A1
(43) Pub. Date: Apr. 24, 2008

(54) Method and apparatus for improved handling of paging requests from neighboring switches

(75) Inventors: David S. Benco, Winfield, IL (US); Paresh C. Kanabar, Naperville, IL (US); John C.V. Nguyen, Naperville, IL (US); Huixian Song, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/582,815

(22) Filed: Oct. 18, 2006

(51) Int. Cl. H04M 11/04

(52) U.S. Cl. 455/404.2

(57) ABSTRACT

This invention relates to a method and apparatus for improved, or optimized, handling of paging requests to a border switch from neighboring switches. More particularly, a technique is provided to reduce the adverse impact of paging requests on border switches while maintaining a high paging success rate. Data representing probabilities that mobile devices are within selected coverage areas, or cells, of the border switch is collected and maintained. The data is used as a basis to more efficiently page mobile devices throughout the selected coverage areas, or cells, of the border switch.

### BACKGROUND OF THE INVENTION

This invention relates to a method and apparatus for improved, or optimized, handling of paging requests to a border switch from neighboring switches. More particularly, a technique is provided to reduce the adverse impact of paging requests on border switches while maintaining a high paging success rate. Data representing probabilities that mobile devices are within selected coverage areas, or cells, of the border switch is collected and maintained. The data is used as a basis to more efficiently page mobile devices throughout the selected coverage areas, or cells, of the border switch.

While the invention is particularly directed to the art of improving paging techniques, and will be thus described with specific reference thereto, it will be appreciated that the invention may have usefulness in other fields and applications. For example, the invention may be applied to any signaling or communication technique where multiple requests are proliferated to obtain a single successful result.

By way of background, in mobile communications and other wireless services, it is necessary to page mobile devices as a prerequisite for offering a useful service. Wireless communications have, therefore, evolved to accommodate this function of paging, and are typically very efficient in locating a mobile device within a coverage area of a given switch, or Mobile Switching Center (MSC).

However, when a mobile device is not found within the coverage area of the Mobile Switching Center (MSC) identified by its Home Location Register (HLR) or Visited Location Register (VLR) (also known as a Serving Mobile Switching Center (SMSC)), the resources used by neighboring systems (also known as Border Mobile Switching Centers (BMSCs)) are disproportionately large. Analysis of field data has shown that nearly half (over 40%) of system paging resources are used to service page requests from Border Mobile Switching Centers (BMSCs). This is particularly troubling given that, by the very nature of transmitting multiple paging requests to locate a single mobile device, the vast majority of paging requests do not result in a successful result.

Therefore, a more efficient process for handling page requests received at border switching elements such as Border Mobile Switching Centers (BMSCs) is desired.

The present invention contemplates a new and improved technique that resolves the above-referenced difficulties and others.

### SUMMARY OF THE INVENTION

A method and apparatus for improved handling, or optimized; of paging requests from neighboring switches are provided.

In one aspect of the invention, the system comprises a first switching element operative to transmit a paging request to locate a mobile device, a database having data stored therein representing probabilities that the mobile device is located in each of a plurality of location areas and a second switching element in communication with a plurality of base stations corresponding to the plurality of location areas and being operative to page the base stations based on the probabilities.

In another aspect of the invention, the first switching element is a Serving Mobile Switching Center (SMSC).

In another aspect of the invention, the second switching element is a Border Mobile Switching Center (BMSC).

In another aspect of the invention, the probabilities define at least low probability location areas and high probability location areas.

In another aspect of the invention, the second switching element is operative to initially page only base stations corresponding to the high probability location areas.

In another aspect of the invention, the second switching element is operative to page a portion of the base stations corresponding to the high probability location areas only during selected time periods.

In another aspect of the invention, the second switching element is operative to page the plurality of base stations in a hierarchical manner based on the probabilities.

In another aspect of the invention, the paging request is an ISPAGE Request.

In another aspect of the invention, the paging request is an ISPAGE2 Request.

In another aspect of the invention, the database is positioned in the second switching element.

In another aspect of the invention, a method comprises receiving a paging request from a switching element to locate a mobile device within a plurality of location areas, identifying at least one base station for which there is a high probability that the mobile device will be located within a corresponding location area and paging the at least one base station to locate the mobile device.

In another aspect of the invention, the method further comprises determining whether the identifying should be conducted.

In another aspect of the invention, the identifying is based on information stored in a database.

In another aspect of the invention, the information defines at least high probability area and low probability areas for location of the mobile device.

In another aspect of the invention, the paging comprises initially paging only base stations corresponding to the high probability location areas.

In another aspect of the invention, the paging comprises paging a portion of the base stations corresponding to the high probability location areas only during selected time periods.

In another aspect of the invention, the paging comprises paging the at least one base station in a hierarchical manner based on the probabilities.

In another aspect of the invention, the method further comprises paging other base stations if the paging of the at least one base station does not result in location of the mobile device.

In another aspect of the invention, means are provided to implement the methods of the invention.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method(s), whereby the objects contemplated are attained as hereinafter more fully set forth, specifically pointed out in the claims, and illustrated in the accompanying drawings in which:

FIG. 1 illustrates a wireless coverage area.

FIG. 2 illustrates a system into which the presently described embodiments may be incorporated.

FIG. 3 illustrates an example database format according to the presently described embodiments.

FIG. 4 is a flow chart illustrating a method according to the presently described embodiments.

### DETAILED DESCRIPTION

The presently described embodiments allow a switching element, e.g. a Border Mobile Switching Center (BMSC), to create and populate a page response database. In one form, the contemplated switching element is operative to maintain a live (e.g. updated in real time) page response database. In this way, the switching element maps each last-known location area (LA) received in an inter-switch page message (e.g. an ISPAGE request or ISPAGE2 request) to corresponding high-probability cells, where the mobile can be most likely successfully paged. In one form, the high-probability collection of cells is also categorized as 1) always page or 2) page during non-busy hours only, as will be described in greater detail below. Low probability cells are typically not paged initially. In this way, the paging success rate for the border switching element and the paging requests can be improved, e.g. maximized, without overloading the available paging resources.

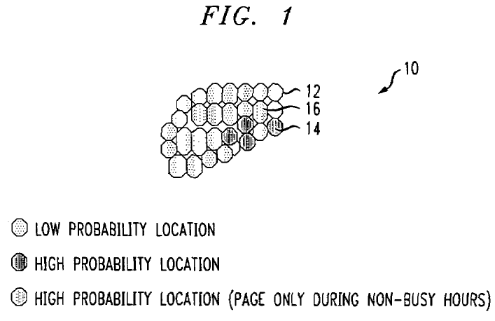

Referring now to the drawings wherein the showings are for purposes of illustrating the exemplary embodiments only and not for purposes of limiting the claimed subject matter, a region 10 of an overall area covered by a switching element of a wireless network is representatively shown in FIG. 1. As illustrated, low probability location areas 12 are represented. Statistically, low probability location areas are regions that exhibit a low probability for location of a particular mobile device, or subscriber, therewithin. In one form of the invention, the base stations corresponding to these location areas, or cells, are not paged unless necessary, as will be described. Of course, as an alternative, some of these location areas may be paged at a time later than the higher probability location areas, but before all areas are paged in the normal course. In this manner, in one form of the invention, a hierarchical paging system based oh the probabilities could be implemented.

Also shown in FIG. 1 are high probability locations 14. These are regions that exhibit a high probability for location of the particular mobile device, or subscriber. For example, these regions may be the locations of the workplaces, homes, . . . , etc. of a population of subscribers. In one form, these areas would always be paged initially to locate the mobile device.

Last, high probability locations 16 are illustrated. These are locations that, during peak hours or other time periods, experience high traffic volume and are considered “busy location areas.” In one form, these locations would only be initially paged during non-busy time periods to help ease the traffic burden that may be experienced.

It should be understood that other categories of probabilities may be used. For example, as alluded to above, different probability thresholds may be used to create a hierarchy of areas (or corresponding base stations) to be paged. Still further, thresholds of probability along with selected time periods or times-of-day could be used in combination to create a hierarchy of areas to be paged.

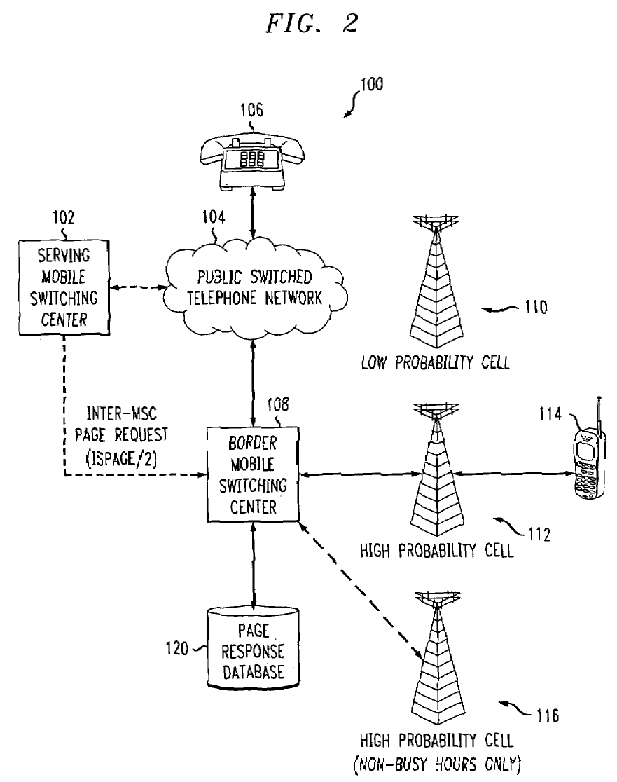

FIG. 2 provides a view of a system into which the presently described embodiments may be incorporated. As shown generally, FIG. 2 illustrates a network 100. It should be understood that the configuration shown is merely exemplary in nature. The network 100 may take a variety of forms, including forms that represent different generations of technology, that are suitable for implementation of the presently described embodiments.

In one form, the network 100 includes a Serving Mobile Switching Center (SMSC) 102 in communication with a Public Switched Telephone Network (PSTN) 104. The Public Switched Telephone Network (PSTN) 104 is in communication with a telephone, or other communication device, 106.

Also shown in the network 100 is Border Mobile Switching Center (BMSC) 108 that is in communication with base stations of a variety of cells, or location areas. As shown, the Border Mobile Switching Center (BMSC) 108 is in communication with a base station of a low probability cell 110. As described above, a low probability cell is a cell that exhibits a low probability for a particular user or population of users to be located. These correlate to the locations 12 in FIG. 1.

The Border Mobile Switching Center (BMSC) 108 is also in communication with a base station of a high probability cell 112. Again, as noted above, the high probability cells are cells wherein a user, such as a user using mobile device 114, or a population of users, is likely to be found. These cells correspond to the areas 14 of FIG. 1.

Also shown in the network 100 is a high probability cell that is busy during specific hours. Cells of this type, such as high probability cell 116, exhibit a high probability that a user or population of users will be present within the cell; however, these cells are so busy during specified hours that it may be more efficient to avoid paging such cells. These cells correspond to the location areas 16 of FIG. 1.

Notably, the network 100, includes a page response database 120. The page response database 120 includes information useful for determining the probabilities that users or populations of users are located within particular cells. For example, the page response database will include information, based on statistics of a population of users, to determine low probability cells, high probability cells, and high probability cells that should be paged only in non-busy hours. This database may be populated in real time and constantly updated upon receipt of each additional call in such a way so that it allows for correlation of low probability cells and high probability cells with respect to each of the serving mobile switching centers, such as serving mobile switching center 102, which serve the Border Mobile Switching Center 108. It should be understood that the population of the database may be accomplished using a variety of data capture and mapping techniques.

The database may also include information to determine the likelihood of location of a particular mobile device for a particular subscriber, as opposed to a population of subscribers. For example, depending on the objectives of the service provider, the information stored in the database may be maintained on a per subscriber basis. In this regard, a subscriber may use its mobile device in only a few primary locations such as home and work. In this case, for this subscriber, the database may store information that will allow for determining these high probability areas. This information may be used as an alternative to the population data contemplated above or as a complement thereto.

It will be appreciated that the database may take a variety of forms that will be apparent to those of ordinary skill in the art. For example, it may be a relational database. The precise information that is stored, and the amount thereof, will be a factor in determining the form of the database. Also, it should be understood that, in one form, the database resides in the border switching element. However, it may also be remotely maintained.

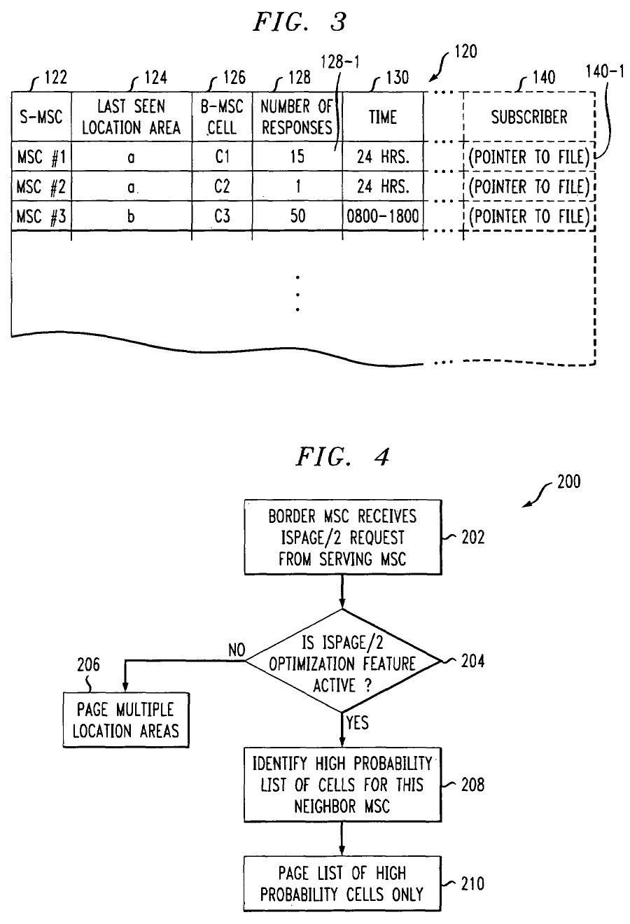

As an example, referring now to FIG. 3, in one form, the page response database 120 includes a variety of fields in which data can be stored, maintained, and updated in real time. As illustrated, the page response database 120 includes a serving MSC field 122 and a last seen location area field 124. It should be understood that the information that populates these two fields is typically contained in the ISPAGE or ISPAGE2 message that is typically received by the border MSC.

The page response database 120 also includes a border MSC cell field 126. A number of responses field 128 and a time field 130 are also shown. The border MSC cell field 126 identifies a particular cell within the border MSC and, as shown, correlates that cell to various serving MSC location areas identified in fields 122 and 124. Field 128 indicates the number of times in which a mobile device was located within the border MSC cell originating from a page response received from a particular serving MSC. The time field 130 illustrates a time period in which the number of responses is maintained. This field can be deployed in terms of days, times of days, hours, or any other quantifiable time value

Also illustrated in FIG. 3 is an optional subscriber field 140 which identifies subscribers that are the source of the data maintained. That is, the subscriber field 140 lists the subscribers that were located in a particular cell within the border MSC identified in field 126.

As alluded to above, the subscriber field 140 is an optional field (shown in dotted lines) and may be implemented in a variety of ways. For example, a subscriber field may simply comprise a pointer to another file, for ease of database management. For example, as shown, the subscriber field entry 140-1 may simply point to a file that identifies the subscribers that are located within cell 1 (c1) of the border MSC as indicated at 128-1 of the number of responses field 128. Of course, the subscribers might simply be listed in the database using, comma separated data or otherwise.

In operation, page response database 120 may be manipulated in a variety of different ways to achieve the objectives of the invention. For example, when a border MSC receives an ISPAGE or ISPAGE2 message, it populates the fields 122 and 124 with data contained therein. As mobile devices within the cells of the border MSCs are located, appropriate data in fields 128 and 140 (if possible) is updated. Now, as to the location of mobile devices, the database 120 is useful, as noted herein, to prioritize the paging that is conducted by the border MSC when it receives the above-noted paging requests. So, as mentioned above, only high probability calls may be paged. In the example shown, it may be that only cell c1 (not c2) is paged upon a paging request from MSC1. Note that c1 has had 15 responses in a 24 hour period, while cell c2 has had only one response. If the threshold for activity is 10 responses in a 24 hour period, then only cell c1 would be paged. Of course, other examples and approaches are contemplated by the present invention.

With reference now to FIG. 4, a method 200 is illustrated. It should be understood that the method 200 may be implemented in different manners using a variety of suitable software routines and/or appropriate hardware configurations. It should also be appreciated that the routines that implement the method may reside in a centralized location, such as on a corresponding switching element, or may be distributed in the network.

In this method 200, a switching element such as a Border Mobile Switching Center (BMSC) 108, receives a paging request such as an ISPAGE2 request from another switching element such as Serving Mobile Switching Center 102 (at 202). Upon receipt of this paging request, a determination is made as to whether the optimization feature is active (at 204). For example, the presently described embodiments may only be implemented during peak hours of use of a particular network. Implementation may not be efficient during non-peak hours. In this case, the data that is used to populate the database may still be recorded. It should also be understood that this step may not be necessary in the case where the presently described embodiments are always active on a switching element.

If the optimization feature is not active, multiple location areas (e.g. all location areas corresponding to the switching element) are paged, as in the ordinary course (at 206). If, however, the optimization feature is active, a list of high probability cells for the MSC that requested the page is identified (at 208). It should be understood that the list of high probability cells may contain only one base station. However, in any event, the list will typically be a subset of all cells corresponding to the switching element. Then, the list of high probability cells is paged.

In a typical case, the desired mobile device will be located through this process. However, in the event that the desired mobile device is not located, a variety of approaches may be exercised by the network. For example, a second paging request may default to page multiple location areas, as in 206. Alternatively, the high probability cells may be re-paged. As a still further alternative, the system may utilize subscriber information (as noted above) relative to cell probabilities to locate the particular subscriber for which the request was made. Still further, a hierarchical paging scheme may be implemented based on the data stored on probabilities and thresholds.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A system comprising:
a first switching element operative to transmit a paging request to locate a mobile device;
a database having data stored therein representing probabilities that the mobile device is located in each of a plurality of location areas; and,
a second switching element in communication with a plurality of base stations corresponding to the plurality of location areas and being operative to page the base stations based on the probabilities.

2. The system as set forth in claim 1 wherein the first switching element is a Serving Mobile Switching Center (SMSC).

3. The system as set forth in claim 1 wherein the second switching element is a Border Mobile Switching Center (BMSC).

4. The system as set forth in claim 1 wherein the probabilities define at least low probability location areas and high probability location areas.

5. The system as set forth in claim 4 wherein the second switching element is operative to initially page only base stations corresponding to the high probability location areas.

6. The system as set forth in claim 5 wherein the second switching element is operative to page a portion of the base stations corresponding to the high probability location areas only during selected time periods.

7. The system as set forth in claim 1 wherein the second switching element is operative to page the plurality of base stations in a hierarchical manner based on the probabilities.

8. The system as set forth in claim 1 wherein the paging request is an ISPAGE Request.

9. The system as set forth in claim 1 wherein the paging request is an ISPAGE2 Request.

10. The system as set forth in claim 1 wherein the database is positioned in the second switching element.

11. A method comprising;
receiving a paging request from a switching element to locate a mobile device within a plurality of location areas;
identifying at least one base station for which there is a high probability that the mobile device will be located within a corresponding location area; and,
paging the at least one base station to locate the mobile device.

12. The method as set forth in claim 11 further comprising determining whether the identifying should be conducted.

13. The method as set forth in claim 11 wherein the identifying is based on information stored in a database.

14. The method as set forth in claim 13 wherein the information defines at least high probability area and low probability areas for location of the mobile device.

15. The method as set forth in claim 14 wherein the paging comprises initially paging only base stations corresponding to the high probability location areas.

16. The method as set forth in claim 16 wherein the paging comprises paging a portion of the base stations corresponding to the high probability location areas only during selected time periods.

17. The method as set forth in claim 11 wherein the paging comprises paging the at least one base station in a hierarchical manner based on the probabilities.

18. The method as set forth in claim 11 further comprising paging other base stations if the paging of the at least one base station does not result in location of the mobile device.

19. A system comprising:
means for receiving a paging request from a switching element to locate a mobile device within a plurality of location areas;
means for identifying at least one base station for which there is a high probability that the mobile device will be located within a corresponding location area; and,
means for paging the at least one base station to locate the mobile device.

20. The system as set forth in claim 19 further comprising means for determining whether the identifying should be conducted.
